(19) United States
(12) Patent Application Publication
(10) Pub. No.: US 2026/0270986 A1
(43) Pub. Date: Sep. 10, 2026

(54) FREQUENCY DOMAIN RESOURCE ALLOCATION FOR FDM BASED MULTI-PANEL SIMULTANEOUS PUSCH TRANSMISSION

(71) Applicant: LENOVO (BEIJING ) LIMITED, Beijing (CN)

(72) Inventors: Bingchao LIU, Beijing (CN); Chenxi ZHU, Fairfax, VA (US); Lingling XIAO, Beijing (CN); Wei LING, Beijing (CN); Yi ZHANG, Beijing (CN)

(21) Appl. No.: 18/875,983

(22) PCT Filed: Jun. 24, 2022
(86) PCT No.: PCT/CN2022/101164

§ 371 Date: Dec. 17, 2024

(51) Int. Cl. H04W 72/1268; H04L 5/00; H04W 72/0453; H04W 72/232

(52) U.S. Cl. CPC H04W 72/1268; H04L 5/001; H04W 72/0453; H04W 72/232

(57) ABSTRACT

Methods and apparatuses for frequency domain resource allocation for FDM based multi-panel simultaneous PUSCH transmission are disclosed. In one embodiment, a UE comprises a transceiver; and a processor coupled to the transceiver, wherein the processor is configured to receive, via the transceiver, a DCI scheduling an FDM based simultaneous multi-panel PUSCH transmission, the DCI indicates the uplink frequency resources used for the FDM based simultaneous multi-panel PUSCH transmission; and determine uplink frequency resources for the PUSCH transmission for a first panel and uplink frequency resources for the PUSCH transmission for a second panel from the indicated uplink frequency resources.

### FIELD

The subject matter disclosed herein generally relates to wireless communications, and more particularly relates to methods and apparatuses for frequency domain resource allocation for FDM based multi-panel simultaneous PUSCH transmission.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Physical Uplink Shared Channel (PUSCH), Simultaneous multi-panel UL transmission (STxMP), Downlink Control Information (DCI), transmission reception point (TRP), Spatial Division Multiplex (SDM), Frequency Division Multiplex (FDM), codebook (CB), non-codebook (nCB), redundant version (RV), Transmission Configuration Indicator (TCI), Physical Downlink Shared Channel (PDSCH), Physical Downlink Control Channel (PDCCH), quasi-colocation (QCL), Demodulation Reference Signal (DMRS), Channel State Information (CSI), Channel State Information Reference Signal (CSI-RS), Physical Uplink Control Channel (PUCCH), control resource set (CORESET), pathloss reference signal (PL-RS), Sounding Reference Signal (SRS), bandwidth part (BWP), resource block (RB), common resource block (CRB), physical resource block (PRB), virtual resource block (VRB), resource block group (RBG), frequency domain resource assignment (FDRA), resource indication value (RIV), Most Significant Bit (MSB), Least Significant Bit (LSB), Transmit Precoding Matrix Indicator (TPMI), FR2 (frequency range 2: 24250 MHz~52600 MHz), medium access control (MAC), control element (CE), Precoding Resource Block Group (PRG).

In NR Release 17, only one PUSCH transmission from a single panel can be transmitted by a UE in a time instance due to power limitation. Simultaneous multi-panel UL transmission (STxMP) shall be supported in NR Release 18 for the UE equipped with multiple panels that can be used for UL transmission.

Both single-DCI based and multi-DCI based multi-TRP STxMP PUSCH schemes can be supported. For single-DCI based multi-TRP simultaneous multi-panel PUSCH transmission, a DCI transmitted from a TRP may schedule one or more (e.g. two) PUSCH transmissions transmitted from multiple (e.g. two) panels of the UE in overlapped time domain resources. For multi-DCI based multi-TRP simultaneous multi-panel PUSCH transmission, each panel (e.g. each of the two panels) of the UE corresponds to (or is associated with) a TRP (e.g. one of the two TRPs). Each TRP (e.g. each of the two TRPs) may send a DCI scheduling a PUSCH transmission transmitted by the panel corresponding to (or associated with) the TRP. Different (e.g. two) PUSCH transmissions transmitted by different panels (e.g. two panels) may overlap in time domain.

Different STxMP schemes (e.g. SDM scheme, FDM scheme) can be supported for single-DCI based multi-TRP simultaneous multi-panel PUSCH transmission. In SDM scheme, different PUSCH layers of a same PUSCH transmission are transmitted by different panels (e.g. two panels) of the UE. In FDM scheme, different frequency resources are allocated for the PUSCH transmissions transmitted from different panels scheduled by a single DCI, while the same time domain resources are used for the PUSCH transmission corresponding to different panels.

One issue for FDM scheme is how to indicate and how to determine the frequency domain resources for the PUSCH transmission transmitted by each panel considering different resource allocation types and potential frequency hopping scheme.

This invention targets frequency domain resource allocation for FDM scheme for single-DCI based multi-TRP simultaneous multi-panel PUSCH transmission.

### BRIEF SUMMARY

Methods and apparatuses for frequency domain resource allocation for FDM based multi-panel simultaneous PUSCH transmission are disclosed.

In one embodiment, a UE comprises a transceiver; and a processor coupled to the transceiver, wherein the processor is configured to receive, via the transceiver, a DCI scheduling an FDM based simultaneous multi-panel PUSCH transmission, the DCI indicates the uplink frequency resources used for the FDM based simultaneous multi-panel PUSCH transmission; and determine uplink frequency resources for the PUSCH transmission for a first panel and uplink frequency resources for the PUSCH transmission for a second panel from the indicated uplink frequency resources.

In some embodiment, when uplink resource allocation type 0 is indicated for the scheduled FDM based simultaneous multi-panel PUSCH transmission, among N RBGs indicated as the uplink frequency resources, where the N RBGs are indexed in the order of increasing frequency as RBG₀ to RBG_{N-1}, all the even indexed RBGs are determined as the uplink frequency resources for the PUSCH transmission for the first panel, and all the odd indexed RBGs are determined as the uplink frequency resources for the PUSCH transmission for the second panel.

In some embodiment, when uplink resource allocation type 1 is indicated for the scheduled FDM based simultaneous multi-panel PUSCH transmission, among contiguous n_{PRB} PRBs indicated as the uplink frequency resources, first

$$⌈ \frac{{n}_{P R B}}{2} ⌉ PRBs$$

are determined as the uplink frequency resources for the PUSCH transmission for the first panel, and the remaining

$$⌈ \frac{{n}_{P R B}}{2} ⌉ PRBs$$

are determined as the uplink frequency resources for the PUSCH transmission for the second panel. In addition, if intra-slot frequency hopping is concurrently configured with FDM-A or FDM-B scheme, then, the starting RB for a first hop of the PUSCH transmission for the first panel is RBₛₜₐᵣₜ, the starting RB for a second hop of the PUSCH transmission for the first panel is RBₛₜₐᵣₜ+RB_{offset,0}, the starting RB for the first hop of the PUSCH transmission for the second panel is

$$R {B}_{start} + ⌈ \frac{{n}_{P R B}}{2} ⌉ ,$$

and the starting RB for the second hop of the PUSCH transmission for the second panel is

$$R {B}_{start} + ⌈ \frac{{n}_{P R B}}{2} ⌉ + R {B}_{offset , 1} .$$

RB_{offset,0} and RB_{offset,1} may be indicated in the scheduling DCI by one of Options 1 to 3, Option 1: N_{UL_hop} MSB bit(s) of an FDRA field indicate the RB_{offset,0} value, and subsequent N_{UL_hop} MSB bit(s) of the FDRA field indicate the RB_{offset,1} value, Option 2: N_{UL_hop} MSB bit(s) of the FDRA field indicate a pair of the RB_{offset,0} value and the RB_{offset,1} value, and Option 3: N_{UL_hop} MSB bit(s) of the FDRA field indicates a single RB_{offset} value which is used as both the RB_{offset,0} value and the RB_{offset}, 1 value. Preferably, the RB_{offset,1} value is equal to or larger than the RB_{offset,0} value.

In some embodiment, when uplink resource allocation type 2 is indicated for the scheduled FDM based simultaneous multi-panel PUSCH transmission, one of schemes 2-1-1, 2-1-2, 2-2-1 and 2-2-2 are adopted, where, the indicated uplink frequency resources are indicated CRBs, scheme 2-1-1: among the Q allocated interlaces where the Q allocated interlaces are indexed in the order of increasing interlace number as indexed allocated interlace #0 to indexed allocated interlace #Q−1, the indicated CRBs corresponding to the first ┌┐ indexed allocated interlace(s) are determined as the uplink frequency resources for the PUSCH transmission for the first panel, and the indicated CRBs corresponding to the remaining └┘ indexed allocated interlace(s) are determined as the uplink frequency resources for the PUSCH transmission for the second panel; scheme 2-1-2: among the Q allocated interlaces where the Q allocated interlaces are indexed in the order of increasing interlace number as indexed allocated interlace #0 to indexed allocated interlace #Q−1, the indicated CRBs corresponding to all the even indexed allocated interlace(s) are determined as the uplink frequency resources for the PUSCH transmission for the first panel, and the indicated CRBs corresponding to all the odd indexed allocated interlace(s) are determined as the uplink frequency resources for the PUSCH transmission for the second panel; scheme 2-2-1: among S CRBs indicated for the scheduled PUSCH transmission corresponding to indicated interlaces for channel occupancy where the S CRBs are indexed in the order of increasing CRB number as indexed CRB₀ to indexed CRB_{S-1}, the first ┌┐ indexed CRBs are determined as the uplink frequency resources for the PUSCH transmission for the first panel, and the remaining └┘ indexed CRBs are determined as the uplink frequency resources for the PUSCH transmission for the second panel; and scheme 2-2-2: among S CRBs indicated for the scheduled PUSCH transmission corresponding to indicated interlaces for channel occupancy where the S CRBs are indexed in the order of increasing CRB number as indexed CRB₀ to indexed CRB_{S-1}, all even indexed CRBs are determined as the uplink frequency resources for the PUSCH transmission for the first panel, and all odd indexed CRBs are determined as the uplink frequency resources for the PUSCH transmission for the second panel.

In some embodiment, the uplink frequency resources for the PUSCH transmission for the first panel and the uplink frequency resources for the PUSCH transmission for the second panel are determined for each subband according to one of schemes 3-1 and 3-2, scheme 3-1: among a subband consisting of T PRBs where the T PRBs are indexed in the order of increasing RB number as indexed PRB₀ to indexed PRB_{T-1}, the first ┌┐ indexed PRBs are determined as the uplink frequency resources for the PUSCH transmission for the first panel, and the remaining └┘ indexed PRBs are determined as the uplink frequency resources for the PUSCH transmission for the second panel; and scheme 3-2: among the PRGs within the allocated frequency domain resources for a subband that are indexed continuously in increasing order with the first PRG index equal to 0, all even indexed PRGs are determined as the uplink frequency resources for the PUSCH transmission for the first panel, and all odd indexed PRGs are determined as the uplink frequency resources for the PUSCH transmission for the second panel. The processor may be further configured to receive, via the transceiver, an RRC parameter along with the RRC parameter configured for FDM-A or FDM-B scheme, the RRC parameter indicates whether scheme 3-1 or scheme 3-2 is used. The processor may be further configured to report, via the transceiver, a capability on whether scheme 3-2 is supported. If no indication of whether scheme 3-1 or scheme 3-2 is used is received, scheme 3-1 may be used. A field in the scheduling DCI may indicate whether scheme 3-1 or scheme 3-2 is used. The processor may be further configured to receive, via the transceiver, a MAC CE to indicate whether scheme 3-1 or scheme 3-2 is used.

In another embodiment, a method performed at a UE comprises receiving a DCI scheduling an FDM based simultaneous multi-panel PUSCH transmission, the DCI indicates the uplink frequency resources used for the FDM based simultaneous multi-panel PUSCH transmission; and determining uplink frequency resources for the PUSCH transmission for a first panel and uplink frequency resources for the PUSCH transmission for a second panel from the indicated uplink frequency resources.

In still another embodiment, a base unit comprises a transceiver; and a processor coupled to the transceiver, wherein the processor is configured to transmit, via the transceiver, a DCI scheduling an FDM based simultaneous multi-panel PUSCH transmission, the DCI indicates the uplink frequency resources used for the FDM based simultaneous multi-panel PUSCH transmission; and determine uplink frequency resources for the PUSCH transmission for a first panel and uplink frequency resources for the PUSCH transmission for a second panel from the indicated uplink frequency resources.

In some embodiment, when uplink resource allocation type 0 is indicated for the scheduled FDM based simultaneous multi-panel PUSCH transmission, among N RBGs indicated as the uplink frequency resources, where the N RBGs are indexed in the order of increasing frequency as RBG₀ to RBG_{N-1}, all the even indexed RBGs are determined as the uplink frequency resources for the PUSCH transmission for the first panel, and all the odd indexed RBGs are determined as the uplink frequency resources for the PUSCH transmission for the second panel.

In some embodiment, when uplink resource allocation type 1 is indicated for the scheduled FDM based simultaneous multi-panel PUSCH transmission, among contiguous n_{PRB} PRBs indicated as the uplink frequency resources, first

$$⌈ \frac{{n}_{P R B}}{2} ⌉ PRBs$$

are determined as the uplink frequency resources for the PUSCH transmission for the first panel, and the remaining

$$⌊ \frac{{n}_{P R B}}{2} ⌋ PRBs$$

are determined as the uplink frequency resources for the PUSCH transmission for the second panel. In addition, if intra-slot frequency hopping is concurrently configured with FDM-A or FDM-B scheme, then, the starting RB for a first hop of the PUSCH transmission for the first panel is RBₛₜₐᵣₜ, the starting RB for a second hop of the PUSCH transmission for the first panel is RBₛₜₐᵣₜ+RB_{offset,0}, the starting RB for the first hop of the PUSCH transmission for the second panel is

$$R {B}_{start} + ⌈ \frac{{n}_{P R B}}{2} ⌉ ,$$

and the starting RB for the second hop of the PUSCH transmission for the second panel is

$$R {B}_{start} + ⌈ \frac{{n}_{P R B}}{2} ⌉ + R {B}_{offset , 1} .$$

RB_{offset,0} and RB_{offset,1} may be indicated in the scheduling DCI by one of Options 1 to 3, Option 1: N_{UL_hop} MSB bit(s) of an FDRA field indicate the RB_{offset,0} value, and subsequent N_{UL_hop} MSB bit(s) of the FDRA field indicate the RB_{offset,1} value, Option 2: N_{UL_hop} MSB bit(s) of the FDRA field indicate a pair of the RB_{offset,0} value and the RB_{offset,1} value, and Option 3: N_{UL_hop} MSB bit(s) of the FDRA field indicates a single RB_{offset} value which is used as both the RB_{offset,0} value and the RB_{offset,1} value. Preferably, the RB_{offset,1} value is equal to or larger than the RB_{offset,0} value.

In some embodiment, when uplink resource allocation type 2 is indicated for the scheduled FDM based simultaneous multi-panel PUSCH transmission, one of schemes 2-1-1, 2-1-2, 2-2-1 and 2-2-2 are adopted, where, the indicated uplink frequency resources are indicated CRBs, scheme 2-1-1: among the Q allocated interlaces where the Q allocated interlaces are indexed in the order of increasing interlace number as indexed allocated interlace #0 to indexed allocated interlace #Q−1, the indicated CRBs corresponding to the first ┌┐ indexed allocated interlace(s) are determined as the uplink frequency resources for the PUSCH transmission for the first panel, and the indicated CRBs corresponding to the remaining └┘ indexed allocated interlace(s) are determined as the uplink frequency resources for the PUSCH transmission for the second panel; scheme 2-1-2: among the Q allocated interlaces where the Q allocated interlaces are indexed in the order of increasing interlace number as indexed allocated interlace #0 to indexed allocated interlace #Q−1, the indicated CRBs corresponding to all the even indexed allocated interlace(s) are determined as the uplink frequency resources for the PUSCH transmission for the first panel, and the indicated CRBs corresponding to all the odd indexed allocated interlace(s) are determined as the uplink frequency resources for the PUSCH transmission for the second panel; scheme 2-2-1: among S CRBs indicated for the scheduled PUSCH transmission corresponding to indicated interlaces for channel occupancy where the S CRBs are indexed in the order of increasing CRB number as indexed CRB₀ to indexed CRB_{S-1}, the first ┌┐ indexed CRBs are determined as the uplink frequency resources for the PUSCH transmission for the first panel, and the remaining └┘ indexed CRBs are determined as the uplink frequency resources for the PUSCH transmission for the second panel; and scheme 2-2-2: among S CRBs indicated for the scheduled PUSCH transmission corresponding to indicated interlaces for channel occupancy where the S CRBs are indexed in the order of increasing CRB number as indexed CRB₀ to indexed CRB_{S-1}, all even indexed CRBs are determined as the uplink frequency resources for the PUSCH transmission for the first panel, and all odd indexed CRBs are determined as the uplink frequency resources for the PUSCH transmission for the second panel.

In some embodiment, the uplink frequency resources for the PUSCH transmission for the first panel and the uplink frequency resources for the PUSCH transmission for the second panel are determined for each subband according to one of schemes 3-1 and 3-2, scheme 3-1: among a subband consisting of T PRBs where the T PRBs are indexed in the order of increasing RB number as indexed PRB₀ to indexed PRB_{T-1}, the first ┌┐ indexed PRBs are determined as the uplink frequency resources for the PUSCH transmission for the first panel, and the remaining └┘ indexed PRBs are determined as the uplink frequency resources for the PUSCH transmission for the second panel; and scheme 3-2: among the PRGs within the allocated frequency domain resources for a subband that are indexed continuously in increasing order with the first PRG index equal to 0, all even indexed PRGs are determined as the uplink frequency resources for the PUSCH transmission for the first panel, and all odd indexed PRGs are determined as the uplink frequency resources for the PUSCH transmission for the second panel. The processor may be further configured to transmit, via the transceiver, an RRC parameter along with the RRC parameter configured for FDM-A or FDM-B scheme, the RRC parameter indicates whether scheme 3-1 or scheme 3-2 is used. The processor may be further configured to receive, via the transceiver. a capability on whether scheme 3-2 is supported. A field in the scheduling DCI may indicate whether scheme 3-1 or scheme 3-2 is used. The processor may be further configured to transmit, via the transceiver, a MAC CE to indicate whether scheme 3-1 or scheme 3-2 is used.

In yet another embodiment, a method performed at a base unit comprises transmitting a DCI scheduling an FDM based simultaneous multi-panel PUSCH transmission, the DCI indicates the uplink frequency resources used for the FDM based simultaneous multi-panel PUSCH transmission; and determining uplink frequency resources for the PUSCH transmission for a first panel and uplink frequency resources for the PUSCH transmission for a second panel from the indicated uplink frequency resources.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a legacy intra-slot frequency hopping for uplink resource allocation type 1;

FIG. 2 illustrates a principle of interlace based frequency resource allocation;

FIG. 3 illustrates an intra-slot frequency hopping for uplink resource allocation type 1 with uplink resource allocation scheme 1;

FIG. 4 is a schematic flow chart diagram illustrating an embodiment of a method;

FIG. 5 is a schematic flow chart diagram illustrating an embodiment of another method; and

FIG. 6 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

First, a brief introduction of the TCI state is provided as follows:

The UE can be configured with a list of up to M TCI-State configurations to decode PDSCH according to a detected PDCCH with DCI intended for the UE and the given serving cell, where M depends on the UE capability. The TCI-state is configured by the following RRC signaling: The IE TCI-State associates one or two DL reference signals with a corresponding quasi-colocation (QCL) type.

| | |
|---|---|
| | TCI-State information element |
| TCI-State ::= | SEQUENCE { |
| tci-StateId | TCI-StateId, |
| qcl-Type1 | QCL-Info, |
| qcl-Type2 | QCL-Info |

...
}

| | |
|---|---|
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, |
| | typeD}, |

...
}

Each TCI-State contains parameters for configuring a quasi co-location (QCL) relationship between one or two downlink reference signals and the DMRS ports of the PDSCH, the DMRS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:

‘QCL-TypeA’: {Doppler shift, Doppler spread, average delay, delay spread}

‘QCL-TypeB’: {Doppler shift, Doppler spread}

‘QCL-TypeC’: {Doppler shift, average delay}

‘QCL-TypeD’: {Spatial Rx parameter}

The UE receives an activation command used to map up to 8 TCI states to the codepoints of the DCI field ‘Transmission Configuration Indication’ in one DL BWP of a serving cell. When a UE supports two TCI states in a codepoint of the DCI field ‘Transmission Configuration Indication’ the UE may receive an activation command, the activation command is used to map up to 8 combinations of one or two TCI states to the codepoints of the DCI field ‘Transmission Configuration Indication’.

In NR Release 17 unified TCI framework, joint DL/UL TCI or separate DL/UL TCI can be configured for a cell by RRC signaling.

When separate DL/UL TCI is configured, the DL TCI state for DL reception and UL TCI state for UL transmission are separately indicated. For UL TCI state, the source reference signal in the UL TCI provides a reference for determining UL TX spatial filter, i.e., the UL TX beam, at least for dynamic-grant or configured-grant based PUSCH and all of dedicated PUCCH resources, which are the PUCCH resources in RRC-connected mode, in a CC. For DL TCI state, the source reference signal(s) (one source reference signal is contained if only the higher layer parameter qcl-Type1 is configured, and two source reference signals are contained if both the higher layer parameter qcl-Type1 and the higher layer parameter qcl_Type2 are configured) in the DL TCI provides QCL information at least for UE-dedicated reception on PDCCH and all the PDSCHs in a CC. Each CORESET is configured by a set time-frequency resource for PDCCH reception. In this situation, a PL-RS is associated with the indicated UL TCI state for path loss calculation. UL power control parameters other than PL-RS (e.g. set of P0, alpha and closed loop index) for PUSCH, PUCCH and SRS may also be associated with the indicated UL TCI state.

When joint DL/UL TCI is configured, both UL TCI state for UL transmission and DL TCI state for DL reception are determined by a single indicated joint DL/UL TCI state. When the joint DL/UL TCI state is configured, a joint TCI refers to at least a common source reference RS used for determining both the DL QCL information and the UL TX spatial filter. For example, the UL TX beam and the DL RX beam are both determined by the QCL-TypeD RS configured in the indicated joint DL/UL TCI state. In this situation, a PL-RS is associated with the indicated joint DL/UL TCI state for path loss calculation. UL power control parameters other than PL-RS (e.g. set of P0, alpha and closed loop index) for PUSCH, PUCCH and SRS may also be associated with the indicated joint DL/UL TCI state.

To support simultaneous multi-panel UL transmission in FR2, two UL TCI states or two joint TCI states should be indicated or activated for a UE in a BWP of a cell, where each UL TCI state corresponds to a UL panel, and each UL TCI state is used to indicate the TX beam and the power control parameters associated with the indicated TX beam.

It is assumed that a first indicated UL or joint TCI state is applied to (or associated with) a first panel and a second indicated UL or joint TCI state is applied to (or associated with) a second panel. The PUSCH transmitted by a panel also means that the PUSCH transmitted by the UL or joint TCI state associated with the panel.

Two FDM schemes named FDM-A scheme and FDM-B scheme are defined as follows.

FDM-A scheme: different parts of the frequency domain resource of one PUSCH transmission occasion are transmitted from different (e.g. two) panels of the UE, where a PUSCH transmission occasion corresponds to a set of time frequency resources for a PUSCH transmission.

FDM-B scheme: two PUSCH transmission occasions with same RV or different RVs of the same TB are transmitted from different (e.g. two) panels of the UE on non-overlapped frequency domain resources and the same time domain resources. Each RV corresponds to a version of the information bits after channel coding, which can be independently decoded.

The UE can be configured in two different modes for PUSCH multi-antenna precoding, referred as codebook (CB) based transmission and non-codebook (nCB) based transmission, respectively. When the UE is configured with codebook based PUSCH transmission, one SRS resource set used for codebook can be configured in a BWP of a cell for the UE. When the UE is configured with non-codebook based PUSCH transmission, one SRS resource set used for non-codebook can be configured in a BWP of a cell for the UE.

To enable codebook based PUSCH transmission, the UE shall be configured to transmit one or more SRS resources used for codebook for uplink channel measurement. Based on the measurements on the configured SRS resources transmitted by the UE, the gNB determines a suitable rank and the precoding matrix from a pre-defined codebook, which includes a set of precoding matrices with different ranks, and sends the information to the UE when scheduling a PUSCH transmission.

For non-codebook based PUSCH transmission, the UE is required to measure a CSI-RS to obtain the uplink channel information based on channel reciprocity. In this case, a CSI-RS resource, which is a DL reference signaling transmitted by the gNB for DL channel measurement, is associated with the SRS resource set used for non-codebook. The UE selects what it believes is a suitable uplink precoder and applies the selected precoder to a set of configured SRS resources with one SRS resource transmitted on each layer defined by the precoder. Based on the received SRS resources, the gNB decides to modify the UE-selected precoder for the scheduled PUSCH transmission.

This disclosure focuses on the issue of allocating frequency resources to the two panels (e.g. a first panel and a second panel). In particular, a single DCI schedules a FDM based simultaneous multi-panel PUSCH transmission, where the DCI indicates the uplink frequency resource (e.g. RBs) used for the scheduled PUSCH transmission. This disclosure proposes different schemes to determine, from the indicated uplink frequency resources, the uplink frequency resources for the PUSCH transmission for the first panel and the uplink frequency resources for the PUSCH transmission for the second panel.

A resource block (RB) is defined as 12 consecutive subcarriers in the frequency domain. Common resource blocks (CRBs) are numbered from 0 and upwards in the frequency domain for a cell (e.g. for all bandwidth parts (BWPs) of the cell). Physical RBs (PRBs) are defined within a BWP and numbered from 0 to

$${N}_{BWP , i}^{size} - 1 ,$$

where i is the number of the BWP. Virtual RBs (VRBs) are defined within a BWP and numbered from 0 to

$${N}_{BWP , i}^{size} - 1$$

where i is the number of the BWP, as specified in 3GPP TS38.211 V17.0.0. Each VRB is mapped to a PRB according to a certain indicated interlaced pattern.

The indicated uplink frequency resources are allocated in different uplink resource allocation types. That is, the indicated uplink frequency resources may be allocated with one of uplink resource allocation type 0, uplink resource allocation type 1 and uplink resource allocation type 2 (abbreviated as allocation type 0, allocation type 1 and allocation type 2 hereinafter), which are specified in 3GPP TS38.214 V17.0.0. For example, the uplink resource allocation type can be indicated by the MSB bit of the FDRA field in the scheduling DCI when dynamic resource allocation type switching is supported.

For allocation type 0, a resource block group (RBG) bitmap is indicated by the FDRA field of the scheduling DCI to indicate the resource blocks (RBs) used for the scheduled PUSCH transmission. The resource allocation (i.e. the indicated RBs used for the scheduled PUSCH transmission) in allocation type 0 may be non-contiguous.

The uplink frequency resources are divided into a set of RBGs for the active BWP, where a RBG consists of one or multiple contiguous RBs depending on the size of the active BWP of the cell. So, a RBG bitmap can indicate the RBG(s) used for the scheduled PUSCH transmission. For example, if there are 18 RBGs in the active BWP, a 18-bits RBG bitmap can indicate the RBGs used for the scheduled PUSCH transmission. For example, each bit set to ‘1’ indicates that the RBG corresponding to the bit is used for the scheduled PUSCH transmission, while each bit set to ‘0’ indicates that the RBG corresponding to the bit is not used for the scheduled PUSCH transmission.

For allocation type 1, a set of contiguously allocated non-interleaved virtual resource blocks (VRBs) are indicated for the UE by indicating resource indication value (RIV) corresponding to a starting VRB (RBₛₜₐᵣₜ) and a length (n_{PRB}) in terms of contiguously allocated resource blocks. The definition of RIV is specified in 3GPP TS38.212 V17.0.0 and TS38.214 V17.0.0.

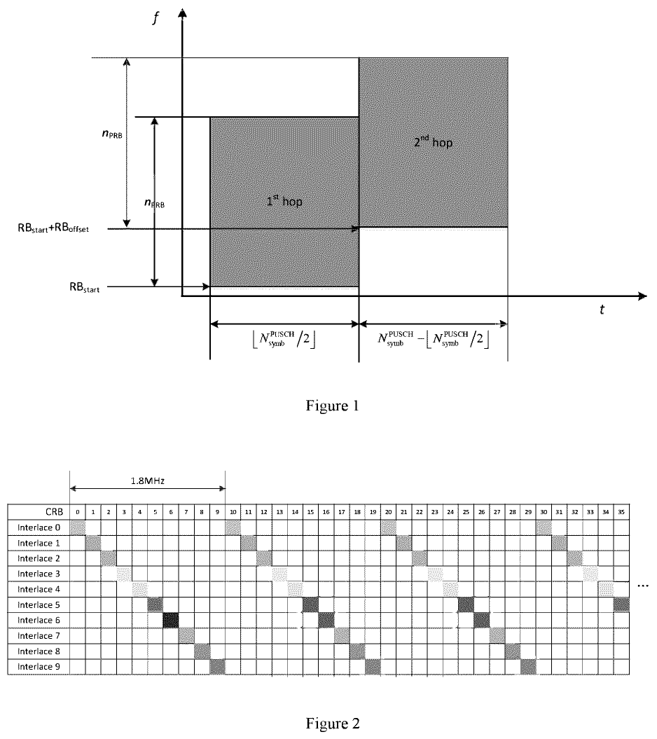

Frequency hopping can be supported for allocation type 1. Intra-slot frequency hopping can be concurrently configured with FDM scheme. For example, as show in FIG. 1, for a first hop, the frequency resource (e.g. RBₛₜₐᵣₜ to RBₛₜₐᵣₜ+n_{PRB}) used for the first

$$⌊ \frac{{N}_{symb}^{PUSCH}}{2} ⌋$$

symbol(s) of the scheduled time resource, and for a second hop, the frequency resource (e.g. RBₛₜₐᵣₜ+RB_{offset} to RBₛₜₐᵣₜ+RB_{offset}+n_{PRB}) used for the remaining

$${N}_{symb}^{PUSCH} - ⌊ \frac{{N}_{symb}^{PUSCH}}{2} ⌋$$

symbol(s) of the scheduled time resource.

In NR Release 17, two or four RB_{offset} values can be configured by RRC parameter frequencyHoppingOffsetLists. One of them is indicated by the frequency domain resource assignment (FDRA) field contained in the scheduling DCI. The N_{UL_hop} MSB bit(s) of the FDRA field indicate the RB_{offset} value. If two RB_{offset} values are configured, N_{UL_hop}=1; and if four RB_{offset} values are configured, N_{UL_hop}=2. Incidentally, when RRC parameter resourceAllocation is configured as ‘dynamicSwitch’, the MSB bit of the FDRA field, that is used for indicating uplink resource allocation type (e.g. uplink resource allocation type 0 by bit value ‘0’, or uplink resource allocation type 1 by bit value ‘1’), is excluded from determining the N_{UL_hop} MSB bit(s) of the FDRA field.

Allocation type 2 applies to unlicensed band operation. In NR Release 17, FR2 operation is extended to unlicensed band, e.g., 60 GHz. In addition, multi-TRP operation is also supported in the unlicensed band. Interlace based frequency resource allocation is adopted for unlicensed band operation to satisfy the channel occupancy requirements.

A brief introduction of interlace based frequency resource allocation is described. For carriers wider than 10 MHz, the overall carrier bandwidth is divided into a number of interlaces. The number of interlaces depends on the subcarrier spacing, e.g. 10 interlaces for 15 kHz subcarrier spacing, and 5 interlaces for 30 kHz subcarrier spacing. The interlaces are based on the common resource blocks (CRB) of a carrier (i.e. all BWPs of the carrier) to have a clean structure and simpler resource allocation for all the BWPs, where each carrier corresponds to a cell. In particular, interlace i consists of CRBs m, m+M, m+2M, . . . , where M denotes the number of interlaces (5 or 10 depending on the subcarrier spacing), and m is from 0 to M+1, and i is one-to-one mapped to m, e.g. i=m. It means that within every M CRBs, CRB m belongs to interlace i. FIG. 2 illustrates an example of the interlaces for 15 kHz subcarrier spacing, in which M=10, i=m.

For allocation type 2, a set of interlaces (e.g. 10 interlaces) is firstly indicated to a UE for channel occupancy. Further, a set of contiguously PRBs are indicated to the UE for data transmission. Only the CRBs in the indicated contiguously PRBs that correspond to the interlaces indicated to the UE can be used by the UE for the scheduled PUSCH transmission.

Below is an example of allocation type 2, if interlaces #2, #3, #4 and #6 are indicated to a UE for channel occupancy, and CRBs #0 to #19 are indicated to the UE for uplink (e.g. PUSCH) transmission, then, the UE will transmit the scheduled PUSCH transmission by using CRBs #2, #3, #4, #6, #12, #13, #14 and #16.

A first embodiment relates to fixed allocation schemes.

PRB bundling, which is used for PDSCH transmission and indicates 2 or 4 adjacent PRBs or all the scheduled PRBs (i.e. wideband) are applied to a same precoding matrix, is not explicitly supported for codebook based PUSCH transmission. Instead, by applying a same precoding matrix to all the scheduled RBs for the codebook based PUSCH transmission, wideband PRB bundling is determined for all the scheduled frequency resources for codebook based PUSCH transmission. In this condition, the uplink frequency resources for the PUSCH transmission for the first panel and the uplink frequency resources for the PUSCH transmission for the second panel are determined for the whole band (e.g. all the scheduled RBs).

Different uplink resource allocation schemes are proposed for different allocation types.

For allocation type 0, N (N is equal to the number of bit(s) in the RBG bitmap that are set to ‘1’) RBGs can be indicated as being used for the scheduled PUSCH transmission, where the N RBGs are indexed in the order of increasing frequency as RBG₀ to RBG_{N-1}. It means that RBG₀ has the lowest frequency.

For allocation type 0, an uplink resource allocation scheme 0 is proposed: among the N RBGs indicated as being used for the scheduled PUSCH transmission, all the even indexed RBGs (i.e. all the (2n)^{th} RBGs, where n is from 0 to

$$⌈ \frac{N}{2} - 1 ⌉ ,$$

where ┌x┐ means the smallest integer that is equal to or larger than x) are determined as a first set of RBGs used for the PUSCH transmission for the first panel and all the odd indexed RBGs (i.e. all the (2n+1)^{th} RBGs, where n is from 0 to

$$⌈ \frac{N - 3}{2} ⌉ )$$

are determined as a second set of RBGs used for the PUSCH transmission for the second panel.

For example, if N=7 (i.e. RBG₀ to RBG₆ are the indicated uplink frequency resources), a first set of RBGs consisting of RBG₀, RBG₂, RBG₄, and RBG₆ are determined as the uplink frequency resources for the PUSCH transmission for the first panel, and a second set of RBGs consisting of RBG₁, RBG₃, and RBG₅ are determined as the uplink frequency resources for the PUSCH transmission for the second panel.

For allocation type 1, an uplink resource allocation scheme 1 is proposed: among the n_{PRB} PRBs indicated as being used for the scheduled PUSCH transmission, first

$$⌈ \frac{{n}_{PRB}}{2} ⌉ PRBs$$

are determined as a first set of PRBs for the PUSCH transmission for the first panel, and the remaining

$$⌊ \frac{{n}_{PRB}}{2} ⌋ PRBs$$

are determined as a second set of PRBs for the PUSCH transmission for the second panel, where └x┘ means the largest integer that is equal to or smaller than x.

The frequency hopping can also be supported for allocation type 1 with uplink resource allocation scheme 1.

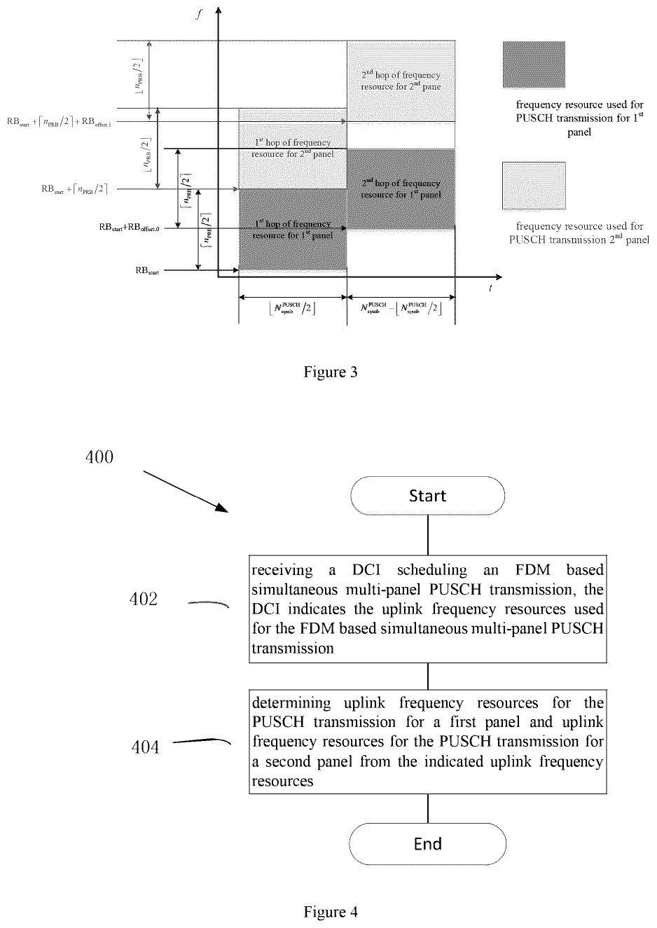

As shown in FIG. 3, the starting RB in each hop i for the first set of PRBs for the PUSCH transmission for the first panel is given by:

$$R {B}_{start} = \{ \begin{matrix}{RB}_{start} & i = 0 \\ ( {RB}_{start} + {RB}_{offset , 0} ) mod {N}_{BWP}^{size} & i = 1\end{matrix}$$

In addition, the starting RB in each hop i for the second set of PRBs for the PUSCH transmission for the second panel is given by

$$R {B}_{start} = \{ \begin{matrix}{RB}_{start} + ⌈ \frac{{n}_{PRB}}{2} ⌉ & i = 0 \\ ( {RB}_{start} + ⌈ \frac{{n}_{PRB}}{2} ⌉ + {RB}_{offset , 1} ) mod {N}_{BWP}^{size} & i = 1\end{matrix}$$

where, i=0 and i=1 are the first hop and the second hop respectively; RBₛₜₐᵣₜ is the starting RB within a UL BWP determined by the indicated RIV. RB_{offset,0} is the frequency offset in RBs between the two frequency hops for the first set of PRBs. RB_{offset,1} is the frequency offset in RBs between the two frequency hops for the second set of PRBs. RB_{offset,0} and RB_{offset,1} should ensure the resources for the second panel are non-overlapped with the resources for the first panel. For example, RB_{offset,0} is equal to or larger than RB_{offset,1}.

$${N}_{BWP}^{size}$$

is the size of the UL BWP in unit of RBs.

As a whole, the frequency resource used for a first half of the scheduled time resource

$$( i . e . ⌊ \frac{{N}_{symb}^{PUSCH}}{2} ⌋ )$$

for the first panel is from RBₛₜₐᵣₜ to

$$R {B}_{start} + ⌈ \frac{{n}_{PRB}}{2} ⌉ ,$$

and the frequency resource used for the first half of the scheduled time resource

$$( i . e . ⌊ \frac{{N}_{symb}^{PUSCH}}{2} ⌋ )$$

for the second panel is from

$$R {B}_{start} + ⌈ \frac{{n}_{PRB}}{2} ⌉$$

to

$$R {B}_{start} + \frac{{n}_{P R B}}{2} .$$

The frequency resource used for the last half of the scheduled time resource

$$( i . e . {N}_{s y m b}^{PUSCH} - ⌊ \frac{{N}_{s y m b}^{PUSCH}}{2} ⌋ )$$

for the first panel is from RBₛₜₐᵣₜ+RB_{offset,0} to

$$R {B}_{start} + R {B}_{o f f s e t , 0} + ⌈ \frac{{n}_{P R B}}{2} ⌉ ,$$

and the frequency resource used for the last half of the scheduled time resource

$$( i . e . {N}_{s y m b}^{PUSCH} - ⌊ \frac{{N}_{s y m b}^{PUSCH}}{2} ⌋ )$$

for the second panel is from

$$R {B}_{start} + ⌈ \frac{{n}_{P R B}}{2} ⌉ + R {B}_{o f f s e t , 1}$$

to

$$R {B}_{start} + \frac{{n}_{P R B}}{2} + R {B}_{o f f s e t , 1} .$$

In FIG. 3, RB_{offset,1} is larger than RB_{offset,0}.

To support indication of two RB_{offset} values (e.g. RB_{offset,0} and RB_{offset,1}) for FDM schemes, three different options can be considered.

Option 1: RB_{offset,0} values and RB_{offset,1} values are separately indicated. The 2*N_{UL_hop} MSB bit(s) of the FDRA field indicate the RB_{offset,0} value and the RB_{offset,1} value. In particular, the N_{UL_hop} MSB bit(s) indicate the RB_{offset,0} value, and the subsequent MSB bit(s) indicate the RB_{offset,1} value. If two RB_{offset,0} values and two RB_{offset,1} values are configured in frequencyHoppingOffsetLists, N_{UL_hop}=1. If four RB_{offset,0} values and four RB_{offset,1} values are configured in frequencyHoppingOffsetLists, N_{UL_hop}=2. Considering the increased DCI overhead for indicating the RB_{offset,1} value (e.g. when two RB_{offset,1} values are configured, 1 additional bit is necessary to indicate the RB_{offset,1} value, and when four RB_{offset,1} values are configured, 2 additional bits are necessary to indicate the RB_{offset,1} value), additional N_{UL_hop} bits (e.g. 1 or 2 bits) for indicating the RB_{offset,1} value can be indicated by the reserved field values of another field, for example, by using two or four reserved DCI field values of antenna port field (which is used to indicate one or more demodulation RS ports for channel estimation) or TPMI field (which is used to indicate a precoding matrix used for the scheduled codebook based PUSCH transmission). That is, when two RB_{offset,1} values are configured, two reserved DCI field values of the antenna port field or TPMI field can indicate the RB_{offset,1} value; while when four RB_{offset,1} values are configured, four reserved DCI field values of the antenna port field or TPMI field can indicate the RB_{offset,1} value. It implies that the FDRA field only indicates the RB_{offset,0} value.

Option 2: two or four pairs of RB_{offset} values (one pair of RB_{offset} values is an RB_{offset,0} value and an RB_{offset,1} value) may be configured by RRC parameter frequencyHoppingOffsetLists. One of the pairs is indicated by N_{UL_hop} MSB bit(s) of the FDRA field contained in the scheduling DCI. If two pairs of RB_{offset} values are configured, N_{UL_hop}=1; and if four pairs of RB_{offset} values are configured, N_{UL_hop}=2.

Option 3: suppose the same RB_{offset} value is applied to both the first panel and the second panel (it means that RB_{offset,0}=RB_{offset,1}), the same indication method as NR Release 17 can be used. That is, two or four RB_{offset} values (that is, RB_{offset,0}=RB_{offset,1}=RB_{offset}) can be configured by RRC parameter frequencyHoppingOffsetLists. One of them is indicated by N_{UL_hop} MSB bit(s) of the FDRA field contained in the scheduling DCI. If two RB_{offset} values are configured, N_{UL_hop}=1; and if four RB_{offset} values are configured, N_{UL_hop}=2.

For allocation type 2, interlace-RB based uplink resource allocation schemes 2-1-1 and 2-1-2 and RB-interlace based uplink resource allocation schemes 2-2-1 and 2-2-2 are proposed.

Interlace-RB based uplink resource allocation scheme 2-1-1: among the Q allocated interlaces where the Q allocated interlaces are indexed in the order of increasing interlace number as allocated interlace #0 to allocated interlace #Q−1, the indicated CRBs corresponding to the first ┌┐ allocated interlace(s) are determined as the uplink frequency resources for the PUSCH transmission for the first panel, and the indicated CRBs corresponding to the remaining └┘ allocated interlace(s) are determined as the uplink frequency resources for the PUSCH transmission for the second panel.

Take the example of allocation type 2, if interlace-RB based uplink resource allocation scheme 2-1-1 is adopted, CRBs #2, #3, #12 and #13 (that are CRBs corresponding to the first 2 allocated interlaces (corresponding to interlaces #2 and #3)) are determined as the uplink frequency resources for the PUSCH transmission for the first panel, and CRBs 4, 6, 14 and 16 (that are CRBs corresponding to the remaining 2 allocated interlaces (corresponding to interlaces #4 and #6)) are determined as the uplink frequency resources for the PUSCH transmission for the second panel.

Interlace-RB based uplink resource allocation scheme 2-1-2: among the Q allocated interlaces where the Q allocated interlaces are indexed in the order of increasing interlace number as allocated interlace #0 to allocated interlace #Q−1, the indicated CRBs corresponding to all the even indexed allocated interlace(s) are determined as the uplink frequency resources for the PUSCH transmission for the first panel, and the indicated CRBs corresponding to all the odd indexed allocated interlace(s) are determined as the uplink frequency resources for the PUSCH transmission for the second panel.

Take the example of allocation type 2, if interlace-RB based uplink resource allocation scheme 2-1-2 is adopted, interlaces #2, #3, #4 and #6 are indexed as allocated interlaces #0, #1, #2 and #3 (even indexed allocated interlace(s), i.e. allocated interlaces #0 and #2, are interlaces #2 and #4, while odd indexed allocated interlace(s), i.e. allocated interlaces #1 and #3, are interlaces #3 and #6), CRBs #2, #4, #12 and #14 (that are the CRBs corresponding to all the even indexed allocated interlaces #0 and #2 (corresponding to allocated interlaces #2 and #4)) are determined as the uplink frequency resources for the PUSCH transmission for the first panel, and CRBs #3, #6, #13 and #16 (that are the CRBs corresponding to all the odd indexed allocated interlaces #1 and #3 (corresponding to allocated interlaces #3 and #6)) are determined as the uplink frequency resources for the PUSCH transmission for the second panel.

For interlace-RB based uplink resource allocation schemes 2-1-1 and 2-1-2, different panels are allocated with CRBs corresponding to different interlaces.

RB-interlace based uplink resource allocation scheme 2-2-1: among S CRBs indicated for the scheduled PUSCH transmission corresponding to indicated interlaces for channel occupancy (where the S CRBs are indexed in the order of increasing CRB number as indexed CRB₀ to indexed CRB_{S-1}), the first ┌┐ indexed CRBs are determined as the uplink frequency resources for the PUSCH transmission for the first panel, and the remaining └┘ indexed CRBs are determined as the uplink frequency resources for the PUSCH transmission for the second panel.

Take the example of allocation type 2, if RB-interlace based uplink resource allocation scheme 2-2-1 is adopted, the S CRBs indicated for the scheduled PUSCH transmission corresponding to indicated interlaces for channel occupancy are CRBs #2, #3, #4, #6, #12, #13, #14 and #16, and they are indexed as indexed CRBs #0 to #7, the first ┌┐ indexed CRBs are indexed CRBs #0 to #3 (corresponding to CRBs #2, #3, #4 and #6) which are determined as the uplink frequency resources for the PUSCH transmission for the first panel, and the remaining └┘ indexed CRBs are indexed CRBs #4 to #7 (i.e. CRBs #12, #13, #14 and #16) which are determined as the uplink frequency resources for the PUSCH transmission for the second panel.

RB-interlace based uplink resource allocation scheme 2-2-2: among S CRBs indicated for the scheduled PUSCH transmission corresponding to indicated interlaces for channel occupancy (where the S CRBs are indexed in the order of increasing CRB number as indexed CRB₀ to indexed CRB_{S-1}), all even indexed CRBs are determined as the uplink frequency resources for the PUSCH transmission for the first panel, and all odd indexed CRBs are determined as the uplink frequency resources for the PUSCH transmission for the second panel.

Take the example of allocation type 2, if RB-interlace based uplink resource allocation scheme 2-2-2 is adopted, the S CRBs indicated for the scheduled PUSCH transmission corresponding to indicated interlaces for channel occupancy are CRBs #2, #3, #4, #6, #12, #13, #14 and #16, and they are indexed as indexed CRBs #0 to #7, all even indexed CRBs are indexed CRBs #0, #2, #4 and #6 (corresponding to CRBs #2, #4, #12, and #14) which are determined as the uplink frequency resources for the PUSCH transmission for the first panel, and all odd indexed CRBs are indexed RBs #1, #3, #5 and #7 (corresponding to CRBs #3, #6, #13, and #16) which are determined as the uplink frequency resources for the PUSCH transmission for the second panel.

A second embodiment relates to dynamic allocation schemes.

Although only wideband precoding can be supported for codebook based PUSCH, subband precoding can be supported for non-codebook based PUSCH by implementation. For example, the UE could apply different subband precodings (e.g. different precoding matrices) for the SRS resources for nCB.

The FDM scheme is configured by RRC signaling. For example, when a higher layer parameter repetitionScheme, which is used to indicate the multi-panel repetition scheme, is set as ‘FDMSchemeA’, FDM-A scheme STxMP PUSCH transmission can be scheduled; and when repetitionScheme is set as ‘FDMSchemeB’, FDM-B scheme STxMP PUSCH transmission can be scheduled.

Two different uplink resource allocation schemes (allocation scheme 3-1 and allocation scheme 3-2) are proposed for the determination of the uplink frequency resources for the first panel and the uplink frequency resources for the second panel for each subband.

Allocation scheme 3-1: among a subband consisting of T PRBs (where the T PRBs are indexed in the order of increasing RB number as indexed PRB₀ to indexed PRB_{T-1}), the first ┌┐ indexed PRBs are determined as the uplink frequency resources for the PUSCH transmission for the first panel, and the remaining └┘ indexed PRBs are determined as the uplink frequency resources for the PUSCH transmission for the second panel. Incidentally, the T PRBs can be contiguous PRBs or non-contiguous PRBs.

Allocation scheme 3-2: among the PRGs within the allocated frequency domain resources for a subband that are numbered continuously in increasing order with the first PRG index equal to 0, even indexed PRGs (including PRG₀) are determined as the uplink frequency resources for the PUSCH transmission for the first panel, and odd indexed PRGs are determined as the uplink frequency resources for the PUSCH transmission for the second panel. One PRG is defined as P contiguous PRBs, where P can be indicated along with the resource allocation scheme indication. Alternatively, the number of PRBs in one PRG can be the same as the RBG size that depends on the size of the active BWP.

Intra-slot frequency hopping is not supported when allocation scheme 3-2 is configured since the allocated frequency domain resources for a subband may be non-contiguous.

Allocation scheme 3-2 can be an optional feature based on UE capability.

Scheme 3-1 or scheme 3-2 can be indicated by RRC parameter, by a MAC CE or by a 1-bit DCI field in the scheduling DCI.

For RRC based indication, scheme 3-1 or scheme 3-2 can be configured along with ‘FDMSchemeA’ or ‘FDMSchemeB’.

For MAC CE based indication, scheme 3-1 or scheme 3-2 is indicated by a dedicated MAC CE containing the following fields:

Serving cell ID and BWP ID for which the MAC CE applies, and the PUSCH configuration in this BWP should be configured to be support ‘FDMSchemeA’ or ‘FDMSchemeB’; and

FDM resource allocation scheme field to indicate that scheme 3-1 or scheme 3-2 is indicated to be applied to the BWP.

For DCI based indication, when ‘FDMSchemeA’ or ‘FDMSchemeB’ is configured by RRC parameter in the BWP, an RRC signaling may configure whether a 1-bit PRB allocation field is contained in scheduling DCI format 0_1 or 0_2. For example, the PRB allocation field, if configured, set to ‘0’ corresponds to scheme 3-1 and set to ‘1’ corresponds to scheme 3-2. If the PRB allocation field is not configured, scheme 3-1 is determined by default. Alternatively, 1 bit, e.g. LSB of the FDRA field can be used to indicate scheme 3-1 or scheme 3-2 for ‘FDMSchemeA’ or ‘FDMSchemeB’.

FIG. 4 is a schematic flow chart diagram illustrating an embodiment of a method 400 according to the present application. In some embodiments, the method 400 is performed by an apparatus, such as a remote unit (e.g. UE). In certain embodiments, the method 400 may be performed by a processor executing program code, for example, a microcontroller, a microprocessor, a CPU, a GPU, an auxiliary processing unit, a FPGA, or the like.

The method 400 is a method performed at a UE, comprising: 402 receiving a DCI scheduling an FDM based simultaneous multi-panel PUSCH transmission, the DCI indicates the uplink frequency resources used for the FDM based simultaneous multi-panel PUSCH transmission; and 404 determining uplink frequency resources for the PUSCH transmission for a first panel and uplink frequency resources for the PUSCH transmission for a second panel from the indicated uplink frequency resources.

In some embodiment, when uplink resource allocation type 0 is indicated for the scheduled FDM based simultaneous multi-panel PUSCH transmission, among N RBGs indicated as the uplink frequency resources, where the N RBGs are indexed in the order of increasing frequency as RBG₀ to RBG_{N-1}, all the even indexed RBGs are determined as the uplink frequency resources for the PUSCH transmission for the first panel, and all the odd indexed RBGs are determined as the uplink frequency resources for the PUSCH transmission for the second panel.

In some embodiment, when uplink resource allocation type 1 is indicated for the scheduled FDM based simultaneous multi-panel PUSCH transmission, among contiguous n_{PRB} PRBs indicated as the uplink frequency resources, first

$$⌈ \frac{{n}_{P R B}}{2} ⌉ PRBs$$

PRBs are determined as the uplink frequency resources for the PUSCH transmission for the first panel, and the remaining

$$⌊ \frac{{n}_{P R B}}{2} ⌋ PRBs$$

are determined as the uplink frequency resources for the PUSCH transmission for the second panel. In addition, if intra-slot frequency hopping is concurrently configured with FDM-A or FDM-B scheme, then, the starting RB for a first hop of the PUSCH transmission for the first panel is RBₛₜₐᵣₜ, the starting RB for a second hop of the PUSCH transmission for the first panel is RBₛₜₐᵣₜ+RB_{offset,0}, the starting RB for the first hop of the PUSCH transmission for the second panel is

$$R {B}_{start} + ⌈ \frac{{n}_{P R B}}{2} ⌉ ,$$

and the starting RB for the second hop of the PUSCH transmission for the second panel is

$$R {B}_{start} + ⌈ \frac{{n}_{P R B}}{2} ⌉ + R {B}_{o f fset , 1} .$$

RB_{offset,0} and RB_{offset,1} may be indicated in the scheduling DCI by one of Options 1 to 3, Option 1: N_{UL_hop} MSB bit(s) of an FDRA field indicate the RB_{offset,0} value, and subsequent N_{UL_hop} MSB bit(s) of the FDRA field indicate the RB_{offset,1} value, Option 2: N_{UL_hop} MSB bit(s) of the FDRA field indicate a pair of the RB_{offset,0} value and the RB_{offset,1} value, and Option 3: N_{UL_hop} MSB bit(s) of the FDRA field indicates a single RB_{offset} value which is used as both the RB_{offset,0} value and the RB_{offset,1} value. Preferably, the RB_{offset,1} value is equal to or larger than the RB_{offset,0} value.

In some embodiment, when uplink resource allocation type 2 is indicated for the scheduled FDM based simultaneous multi-panel PUSCH transmission, one of schemes 2-1-1, 2-1-2, 2-2-1 and 2-2-2 are adopted, where, the indicated uplink frequency resources are indicated CRBs, scheme 2-1-1: among the Q allocated interlaces where the Q allocated interlaces are indexed in the order of increasing interlace number as indexed allocated interlace #0 to indexed allocated interlace #Q−1, the indicated CRBs corresponding to the first ┌┐ indexed allocated interlace(s) are determined as the uplink frequency resources for the PUSCH transmission for the first panel, and the indicated CRBs corresponding to the remaining └┘ indexed allocated interlace(s) are determined as the uplink frequency resources for the PUSCH transmission for the second panel; scheme 2-1-2: among the Q allocated interlaces where the Q allocated interlaces are indexed in the order of increasing interlace number as indexed allocated interlace #0 to indexed allocated interlace #Q−1, the indicated CRBs corresponding to all the even indexed allocated interlace(s) are determined as the uplink frequency resources for the PUSCH transmission for the first panel, and the indicated CRBs corresponding to all the odd indexed allocated interlace(s) are determined as the uplink frequency resources for the PUSCH transmission for the second panel; scheme 2-2-1: among S CRBs indicated for the scheduled PUSCH transmission corresponding to indicated interlaces for channel occupancy where the S CRBs are indexed in the order of increasing CRB number as indexed CRB₀ to indexed CRB_{S-1}, the first ┌┐ indexed CRBs are determined as the uplink frequency resources for the PUSCH transmission for the first panel, and the remaining └┘ indexed CRBs are determined as the uplink frequency resources for the PUSCH transmission for the second panel; and scheme 2-2-2: among S CRBs indicated for the scheduled PUSCH transmission corresponding to indicated interlaces for channel occupancy where the S CRBs are indexed in the order of increasing CRB number as indexed CRB₀ to indexed CRB_{S-1}, all even indexed CRBs are determined as the uplink frequency resources for the PUSCH transmission for the first panel, and all odd indexed CRBs are determined as the uplink frequency resources for the PUSCH transmission for the second panel.

In some embodiment, the uplink frequency resources for the PUSCH transmission for the first panel and the uplink frequency resources for the PUSCH transmission for the second panel are determined for each subband according to one of schemes 3-1 and 3-2, scheme 3-1: among a subband consisting of T PRBs where the T PRBs are indexed in the order of increasing RB number as indexed PRB₀ to indexed PRB_{T-1}, the first ┌┐ indexed PRBs are determined as the uplink frequency resources for the PUSCH transmission for the first panel, and the remaining └┘ indexed PRBs are determined as the uplink frequency resources for the PUSCH transmission for the second panel; and scheme 3-2: among the PRGs within the allocated frequency domain resources for a subband that are indexed continuously in increasing order with the first PRG index equal to 0, all even indexed PRGs are determined as the uplink frequency resources for the PUSCH transmission for the first panel, and all odd indexed PRGs are determined as the uplink frequency resources for the PUSCH transmission for the second panel. The method may further comprise receiving an RRC parameter along with the RRC parameter configured for FDM-A or FDM-B scheme, the RRC parameter indicates whether scheme 3-1 or scheme 3-2 is used. The method may further comprise reporting a capability on whether scheme 3-2 is supported. If no indication of whether scheme 3-1 or scheme 3-2 is used is received, scheme 3-1 may be used. A field in the scheduling DCI may indicate whether scheme 3-1 or scheme 3-2 is used. The method may further comprise receiving a MAC CE to indicate whether scheme 3-1 or scheme 3-2 is used.

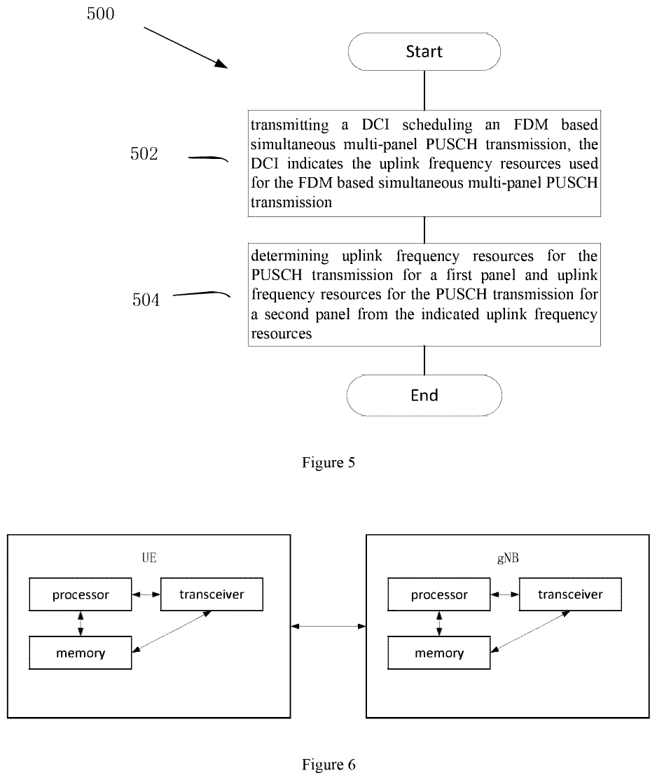

FIG. 5 is a schematic flow chart diagram illustrating an embodiment of a method 500 according to the present application. In some embodiments, the method 500 is performed by an apparatus, such as a base unit. In certain embodiments, the method 500 may be performed by a processor executing program code, for example, a microcontroller, a microprocessor, a CPU, a GPU, an auxiliary processing unit, a FPGA, or the like.

The method 500 may comprise 502 transmitting a DCI scheduling an FDM based simultaneous multi-panel PUSCH transmission, the DCI indicates the uplink frequency resources used for the FDM based simultaneous multi-panel PUSCH transmission; and 504 determining uplink frequency resources for the PUSCH transmission for a first panel and uplink frequency resources for the PUSCH transmission for a second panel from the indicated uplink frequency resources.

In some embodiment, when uplink resource allocation type 0 is indicated for the scheduled FDM based simultaneous multi-panel PUSCH transmission, among N RBGs indicated as the uplink frequency resources, where the N RBGs are indexed in the order of increasing frequency as RBG₀ to RBG_{N-1}, all the even indexed RBGs are determined as the uplink frequency resources for the PUSCH transmission for the first panel, and all the odd indexed RBGs are determined as the uplink frequency resources for the PUSCH transmission for the second panel.

In some embodiment, when uplink resource allocation type 1 is indicated for the scheduled FDM based simultaneous multi-panel PUSCH transmission, among contiguous n_{PRB} PRBs indicated as the uplink frequency resources, first

$$⌈ \frac{{n}_{P R B}}{2} ⌉ PRBs$$

are determined as the uplink frequency resources for the PUSCH transmission for the first panel, and the remaining

$$⌊ \frac{{n}_{P R B}}{2} ⌋ PRBs$$

are determined as the uplink frequency resources for the PUSCH transmission for the second panel. In addition, if intra-slot frequency hopping is concurrently configured with FDM-A or FDM-B scheme, then, the starting RB for a first hop of the PUSCH transmission for the first panel is RBₛₜₐᵣₜ, the starting RB for a second hop of the PUSCH transmission for the first panel is RBₛₜₐᵣₜ+RB_{offset,0}, the starting RB for the first hop of the PUSCH transmission for the second panel is

$$R {B}_{start} + ⌈ \frac{{n}_{P R B}}{2} ⌉ ,$$

and the starting RB for the second hop of the PUSCH transmission for the second panel is

$$R {B}_{start} + ⌈ \frac{{n}_{P R B}}{2} ⌉ + R {B}_{offset , 1} .$$

RB_{offset,0} and RB_{offset,1} may be indicated in the scheduling DCI by one of Options 1 to 3, Option 1: N_{UL_hop} MSB bit(s) of an FDRA field indicate the RB_{offset,0} value, and subsequent N_{UL_hop} MSB bit(s) of the FDRA field indicate the RB_{offset,1} value, Option 2: N_{UL_hop} MSB bit(s) of the FDRA field indicate a pair of the RB_{offset,0} value and the RB_{offset,1} value, and Option 3: N_{UL_hop} MSB bit(s) of the FDRA field indicates a single RB_{offset} value which is used as both the RB_{offset,0} value and the RB_{offset,1} value. Preferably, the RB_{offset,1} value is equal to or larger than the RB_{offset,0} value.

In some embodiment, when uplink resource allocation type 2 is indicated for the scheduled FDM based simultaneous multi-panel PUSCH transmission, one of schemes 2-1-1, 2-1-2, 2-2-1 and 2-2-2 are adopted, where, the indicated uplink frequency resources are indicated CRBs, scheme 2-1-1: among the Q allocated interlaces where the Q allocated interlaces are indexed in the order of increasing interlace number as indexed allocated interlace #0 to indexed allocated interlace #Q−1, the indicated CRBs corresponding to the first ┌┐ indexed allocated interlace(s) are determined as the uplink frequency resources for the PUSCH transmission for the first panel, and the indicated CRBs corresponding to the remaining └┘ indexed allocated interlace(s) are determined as the uplink frequency resources for the PUSCH transmission for the second panel; scheme 2-1-2: among the Q allocated interlaces where the Q allocated interlaces are indexed in the order of increasing interlace number as indexed allocated interlace #0 to indexed allocated interlace #Q−1, the indicated CRBs corresponding to all the even indexed allocated interlace(s) are determined as the uplink frequency resources for the PUSCH transmission for the first panel, and the indicated CRBs corresponding to all the odd indexed allocated interlace(s) are determined as the uplink frequency resources for the PUSCH transmission for the second panel; scheme 2-2-1: among S CRBs indicated for the scheduled PUSCH transmission corresponding to indicated interlaces for channel occupancy where the S CRBs are indexed in the order of increasing CRB number as indexed CRB₀ to indexed CRB_{S-1}, the first ┌┐ indexed CRBs are determined as the uplink frequency resources for the PUSCH transmission for the first panel, and the remaining └┘ indexed CRBs are determined as the uplink frequency resources for the PUSCH transmission for the second panel; and scheme 2-2-2: among S CRBs indicated for the scheduled PUSCH transmission corresponding to indicated interlaces for channel occupancy where the S CRBs are indexed in the order of increasing CRB number as indexed CRB₀ to indexed CRB_{S-1}, all even indexed CRBs are determined as the uplink frequency resources for the PUSCH transmission for the first panel, and all odd indexed CRBs are determined as the uplink frequency resources for the PUSCH transmission for the second panel.

In some embodiment, the uplink frequency resources for the PUSCH transmission for the first panel and the uplink frequency resources for the PUSCH transmission for the second panel are determined for each subband according to one of schemes 3-1 and 3-2, scheme 3-1: among a subband consisting of T PRBs where the T PRBs are indexed in the order of increasing RB number as indexed PRB₀ to indexed PRB_{T-1}, the first ┌┐ indexed PRBs are determined as the uplink frequency resources for the PUSCH transmission for the first panel, and the remaining └┘ indexed PRBs are determined as the uplink frequency resources for the PUSCH transmission for the second panel; and scheme 3-2: among the PRGs within the allocated frequency domain resources for a subband that are indexed continuously in increasing order with the first PRG index equal to 0, all even indexed PRGs are determined as the uplink frequency resources for the PUSCH transmission for the first panel, and all odd indexed PRGs are determined as the uplink frequency resources for the PUSCH transmission for the second panel. The method may further comprise transmitting an RRC parameter along with the RRC parameter configured for FDM-A or FDM-B scheme, the RRC parameter indicates whether scheme 3-1 or scheme 3-2 is used. The method may further comprise receiving a capability on whether scheme 3-2 is supported. A field in the scheduling DCI may indicate whether scheme 3-1 or scheme 3-2 is used. The method may further comprise transmitting a MAC CE to indicate whether scheme 3-1 or scheme 3-2 is used.

FIG. 6 is a schematic block diagram illustrating apparatuses according to one embodiment.

Referring to FIG. 6, the UE (i.e. the remote unit) includes a processor, a memory, and a transceiver. The processor implements a function, a process, and/or a method which are proposed in FIG. 4.

The UE comprises a transceiver; and a processor coupled to the transceiver, wherein the processor is configured to receive, via the transceiver, a DCI scheduling an FDM based simultaneous multi-panel PUSCH transmission, the DCI indicates the uplink frequency resources used for the FDM based simultaneous multi-panel PUSCH transmission; and determine uplink frequency resources for the PUSCH transmission for a first panel and uplink frequency resources for the PUSCH transmission for a second panel from the indicated uplink frequency resources.

In some embodiment, when uplink resource allocation type 0 is indicated for the scheduled FDM based simultaneous multi-panel PUSCH transmission, among N RBGs indicated as the uplink frequency resources, where the N RBGs are indexed in the order of increasing frequency as RBG₀ to RBG_{N-1}, all the even indexed RBGs are determined as the uplink frequency resources for the PUSCH transmission for the first panel, and all the odd indexed RBGs are determined as the uplink frequency resources for the PUSCH transmission for the second panel.

In some embodiment, when uplink resource allocation type 1 is indicated for the scheduled FDM based simultaneous multi-panel PUSCH transmission, among contiguous n_{PRB} PRBs indicated as the uplink frequency resources, first

$$⌈ \frac{{n}_{P R B}}{2} ⌉ PRBs$$

are determined as the uplink frequency resources for the PUSCH transmission for the first panel, and the remaining

$$⌊ \frac{{n}_{PRB}}{2} ⌋ PRBs$$

are determined as the uplink frequency resources for the PUSCH transmission for the second panel. In addition, if intra-slot frequency hopping is concurrently configured with FDM-A or FDM-B scheme, then, the starting RB for a first hop of the PUSCH transmission for the first panel is RBₛₜₐᵣₜ, the starting RB for a second hop of the PUSCH transmission for the first panel is RBₛₜₐᵣₜ+RB_{offset,0}, the starting RB for the first hop of the PUSCH transmission for the second panel is

$${RB}_{start} + ⌈ \frac{{n}_{PRB}}{2} ⌉ ,$$

and the starting RB for the second hop of the PUSCH transmission for the second panel is

$${RB}_{start} + ⌈ \frac{{n}_{PRB}}{2} ⌉ + {RB}_{offset , 1} .$$

RB_{offset,0} and RB_{offset,1} may be indicated in the scheduling DCI by one of Options 1 to 3, Option 1: N_{UL_hop} MSB bit(s) of an FDRA field indicate the RB_{offset,0} value, and subsequent N_{UL_hop} MSB bit(s) of the FDRA field indicate the RB_{offset,1} value, Option 2: N_{UL_hop} MSB bit(s) of the FDRA field indicate a pair of the RB_{offset,0} value and the RB_{offset,1} value, and Option 3: N_{UL_hop} MSB bit(s) of the FDRA field indicates a single RB_{offset} value which is used as both the RB_{offset,0} value and the RB_{offset,1} value. Preferably, the RB_{offset,1} value is equal to or larger than the RB_{offset,0} value.

In some embodiment, when uplink resource allocation type 2 is indicated for the scheduled FDM based simultaneous multi-panel PUSCH transmission, one of schemes 2-1-1, 2-1-2, 2-2-1 and 2-2-2 are adopted, where, the indicated uplink frequency resources are indicated CRBs, scheme 2-1-1: among the Q allocated interlaces where the Q allocated interlaces are indexed in the order of increasing interlace number as indexed allocated interlace #0 to indexed allocated interlace #Q−1, the indicated CRBs corresponding to the first ┌┐ indexed allocated interlace(s) are determined as the uplink frequency resources for the PUSCH transmission for the first panel, and the indicated CRBs corresponding to the remaining └┘ indexed allocated interlace(s) are determined as the uplink frequency resources for the PUSCH transmission for the second panel; scheme 2-1-2: among the Q allocated interlaces where the Q allocated interlaces are indexed in the order of increasing interlace number as indexed allocated interlace #0 to indexed allocated interlace #Q−1, the indicated CRBs corresponding to all the even indexed allocated interlace(s) are determined as the uplink frequency resources for the PUSCH transmission for the first panel, and the indicated CRBs corresponding to all the odd indexed allocated interlace(s) are determined as the uplink frequency resources for the PUSCH transmission for the second panel; scheme 2-2-1: among S CRBs indicated for the scheduled PUSCH transmission corresponding to indicated interlaces for channel occupancy where the S CRBs are indexed in the order of increasing CRB number as indexed CRB₀ to indexed CRB_{S-1}, the first ┌┐ indexed CRBs are determined as the uplink frequency resources for the PUSCH transmission for the first panel, and the remaining └┘ indexed CRBs are determined as the uplink frequency resources for the PUSCH transmission for the second panel; and scheme 2-2-2: among S CRBs indicated for the scheduled PUSCH transmission corresponding to indicated interlaces for channel occupancy where the S CRBs are indexed in the order of increasing CRB number as indexed CRB₀ to indexed CRB_{S-1}, all even indexed CRBs are determined as the uplink frequency resources for the PUSCH transmission for the first panel, and all odd indexed CRBs are determined as the uplink frequency resources for the PUSCH transmission for the second panel.

In some embodiment, the uplink frequency resources for the PUSCH transmission for the first panel and the uplink frequency resources for the PUSCH transmission for the second panel are determined for each subband according to one of schemes 3-1 and 3-2, scheme 3-1: among a subband consisting of T PRBs where the T PRBs are indexed in the order of increasing RB number as indexed PRB₀ to indexed PRB_{T-1}, the first ┌┐ indexed PRBs are determined as the uplink frequency resources for the PUSCH transmission for the first panel, and the remaining └┘ indexed PRBs are determined as the uplink frequency resources for the PUSCH transmission for the second panel; and scheme 3-2: among the PRGs within the allocated frequency domain resources for a subband that are indexed continuously in increasing order with the first PRG index equal to 0, all even indexed PRGs are determined as the uplink frequency resources for the PUSCH transmission for the first panel, and all odd indexed PRGs are determined as the uplink frequency resources for the PUSCH transmission for the second panel. The processor may be further configured to receive, via the transceiver, an RRC parameter along with the RRC parameter configured for FDM-A or FDM-B scheme, the RRC parameter indicates whether scheme 3-1 or scheme 3-2 is used. The processor may be further configured to report, via the transceiver, a capability on whether scheme 3-2 is supported. If no indication of whether scheme 3-1 or scheme 3-2 is used is received, scheme 3-1 may be used. A field in the scheduling DCI may indicate whether scheme 3-1 or scheme 3-2 is used. The processor may be further configured to receive, via the transceiver, a MAC CE to indicate whether scheme 3-1 or scheme 3-2 is used.

The gNB (i.e. the base unit) includes a processor, a memory, and a transceiver. The processor implements a function, a process, and/or a method which are proposed in FIG. 5.

The base unit comprises a transceiver; and a processor coupled to the transceiver, wherein the processor is configured to transmit, via the transceiver, a DCI scheduling an FDM based simultaneous multi-panel PUSCH transmission, the DCI indicates the uplink frequency resources used for the FDM based simultaneous multi-panel PUSCH transmission; and determine uplink frequency resources for the PUSCH transmission for a first panel and uplink frequency resources for the PUSCH transmission for a second panel from the indicated uplink frequency resources.

In some embodiment, when uplink resource allocation type 0 is indicated for the scheduled FDM based simultaneous multi-panel PUSCH transmission, among N RBGs indicated as the uplink frequency resources, where the N RBGs are indexed in the order of increasing frequency as RBG₀ to RBG_{N-1}, all the even indexed RBGs are determined as the uplink frequency resources for the PUSCH transmission for the first panel, and all the odd indexed RBGs are determined as the uplink frequency resources for the PUSCH transmission for the second panel.

In some embodiment, when uplink resource allocation type 1 is indicated for the scheduled FDM based simultaneous multi-panel PUSCH transmission, among contiguous n_{PRB} PRBs indicated as the uplink frequency resources, first

$$⌈ \frac{{n}_{PRB}}{2} ⌉ PRBs$$

are determined as the uplink frequency resources for the PUSCH transmission for the first panel, and the remaining

$$⌊ \frac{{n}_{PRB}}{2} ⌋ PRBs$$

are determined as the uplink frequency resources for the PUSCH transmission for the second panel. In addition, if intra-slot frequency hopping is concurrently configured with FDM-A or FDM-B scheme, then, the starting RB for a first hop of the PUSCH transmission for the first panel is RBₛₜₐᵣₜ, the starting RB for a second hop of the PUSCH transmission for the first panel is RBₛₜₐᵣₜ+RB_{offset,0}, the starting RB for the first hop of the PUSCH transmission for the second panel is

$${RB}_{start} + ⌈ \frac{{n}_{PRB}}{2} ⌉ ,$$

and the starting RB for the second hop of the PUSCH transmission for the second panel is

$${RB}_{start} + ⌈ \frac{{n}_{PRB}}{2} ⌉ + {RB}_{offset , 1} .$$

RB_{offset,0} and RB_{offset,1} may be indicated in the scheduling DCI by one of Options 1 to 3, Option 1: N_{UL_hop} MSB bit(s) of an FDRA field indicate the RB_{offset,0} value, and subsequent N_{UL_hop} MSB bit(s) of the FDRA field indicate the RB_{offset,1} value, Option 2: N_{UL_hop} MSB bit(s) of the FDRA field indicate a pair of the RB_{offset,0} value and the RB_{offset,1} value, and Option 3: N_{UL_hop} MSB bit(s) of the FDRA field indicates a single RB_{offset} value which is used as both the RB_{offset,0} value and the RB_{offset,1} value. Preferably, the RB_{offset,1} value is equal to or larger than the RB_{offset,0} value.

In some embodiment, when uplink resource allocation type 2 is indicated for the scheduled FDM based simultaneous multi-panel PUSCH transmission, one of schemes 2-1-1, 2-1-2, 2-2-1 and 2-2-2 are adopted, where, the indicated uplink frequency resources are indicated CRBs, scheme 2-1-1: among the Q allocated interlaces where the Q allocated interlaces are indexed in the order of increasing interlace number as indexed allocated interlace #0 to indexed allocated interlace #Q−1, the indicated CRBs corresponding to the first ┌┐ indexed allocated interlace(s) are determined as the uplink frequency resources for the PUSCH transmission for the first panel, and the indicated CRBs corresponding to the remaining └┘ indexed allocated interlace(s) are determined as the uplink frequency resources for the PUSCH transmission for the second panel; scheme 2-1-2: among the Q allocated interlaces where the Q allocated interlaces are indexed in the order of increasing interlace number as indexed allocated interlace #0 to indexed allocated interlace #Q−1, the indicated CRBs corresponding to all the even indexed allocated interlace(s) are determined as the uplink frequency resources for the PUSCH transmission for the first panel, and the indicated CRBs corresponding to all the odd indexed allocated interlace(s) are determined as the uplink frequency resources for the PUSCH transmission for the second panel; scheme 2-2-1: among S CRBs indicated for the scheduled PUSCH transmission corresponding to indicated interlaces for channel occupancy where the S CRBs are indexed in the order of increasing CRB number as indexed CRB₀ to indexed CRB_{S-1}, the first ┌┐ indexed CRBs are determined as the uplink frequency resources for the PUSCH transmission for the first panel, and the remaining └┘ indexed CRBs are determined as the uplink frequency resources for the PUSCH transmission for the second panel; and scheme 2-2-2: among S CRBs indicated for the scheduled PUSCH transmission corresponding to indicated interlaces for channel occupancy where the S CRBs are indexed in the order of increasing CRB number as indexed CRB₀ to indexed CRB_{S-1}, all even indexed CRBs are determined as the uplink frequency resources for the PUSCH transmission for the first panel, and all odd indexed CRBs are determined as the uplink frequency resources for the PUSCH transmission for the second panel.

In some embodiment, the uplink frequency resources for the PUSCH transmission for the first panel and the uplink frequency resources for the PUSCH transmission for the second panel are determined for each subband according to one of schemes 3-1 and 3-2, scheme 3-1: among a subband consisting of T PRBs where the T PRBs are indexed in the order of increasing RB number as indexed PRB₀ to indexed PRB_{T-1}, the first ┌┐ indexed PRBs are determined as the uplink frequency resources for the PUSCH transmission for the first panel, and the remaining └┘ indexed PRBs are determined as the uplink frequency resources for the PUSCH transmission for the second panel; and scheme 3-2: among the PRGs within the allocated frequency domain resources for a subband that are indexed continuously in increasing order with the first PRG index equal to 0, all even indexed PRGs are determined as the uplink frequency resources for the PUSCH transmission for the first panel, and all odd indexed PRGs are determined as the uplink frequency resources for the PUSCH transmission for the second panel. The processor may be further configured to transmit, via the transceiver, an RRC parameter along with the RRC parameter configured for FDM-A or FDM-B scheme, the RRC parameter indicates whether scheme 3-1 or scheme 3-2 is used. The processor may be further configured to receive, via the transceiver. a capability on whether scheme 3-2 is supported. A field in the scheduling DCI may indicate whether scheme 3-1 or scheme 3-2 is used. The processor may be further configured to transmit, via the transceiver, a MAC CE to indicate whether scheme 3-1 or scheme 3-2 is used.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive downlink control information (DCI) scheduling a frequency division multiplexing (FDM) based simultaneous multi-panel physical uplink shared channel (PUSCH) transmission, wherein the DCI indicates uplink frequency resources used for the FDM based simultaneous multi-panel PUSCH transmission; and
determine uplink frequency resources for the PUSCH transmission for a first panel and uplink frequency resources for the PUSCH transmission for a second panel from the indicated uplink frequency resources.

2. The UE of claim 1, wherein, when uplink resource allocation type 0 is indicated for the scheduled FDM based simultaneous multi-panel PUSCH transmission, among N resource block groups (RBGs) indicated as the uplink frequency resources, where the N RBGs are indexed in an order of increasing frequency as RBG₀ to RBG_{N-1}, all even indexed RBGs are determined as the uplink frequency resources for the PUSCH transmission for the first panel, and all odd indexed RBGs are determined as the uplink frequency resources for the PUSCH transmission for the second panel.

3. The UE of claim 1, wherein, when uplink resource allocation type 1 is indicated for the scheduled FDM based simultaneous multi-panel PUSCH transmission, among contiguous n_{PRB} physical resource blocks (PRBs) indicated as the uplink frequency resources, first
$$⌈ \frac{{n}_{PRB}}{2} ⌉ PRBs$$
are determined as uplink frequency resources for the PUSCH transmission for the first panel, and remaining
$$⌊ \frac{{n}_{PRB}}{2} ⌋ PRBs$$
are determined as uplink frequency resources for the PUSCH transmission for the second panel.

4. The UE of claim 3, wherein, when intra-slot frequency hopping is concurrently configured with an FDM-A or an FDM-B scheme,
a starting resource block (RB) for a first hop of the PUSCH transmission for the first panel is RBₛₜₐᵣₜ,
a starting RB for a second hop of the PUSCH transmission for the first panel is RBₛₜₐᵣₜ+RB_{offset,0},
a starting RB for the first hop of the PUSCH transmission for the second panel is
$${RB}_{start} + ⌈ \frac{{n}_{PRB}}{2} ⌉ ,$$
and
a starting RB for the second hop of the PUSCH transmission for the second panel is
$${RB}_{start} + ⌈ \frac{{n}_{PRB}}{2} ⌉ + {RB}_{offset , 1} .$$

5. The UE of claim 4, wherein RB_{offset,0} and RB_{offset,1} are indicated in the scheduling DCI by:
N_{UL_hop} most significant bits (MSB) bits of frequency domain resource allocation (FDRA) field indicate the RB_{offset,0} value, and subsequent N_{UL_hop} MSB bits of the FDRA field indicate the RB_{offset,1} value,
N_{UL_hop} MSB bits of the FDRA field indicate a pair of the RB_{offset,0} value and the RB_{offset,1} value, and
N_{UL_hop} MSB bits of the FDRA field indicates a single RB_{offset} value which is used as both the RB_{offset,0} value and the RB_{offset,1} value.

6. The UE of claim 4, wherein the RB_{offset,1} value is equal to or larger than the RB_{offset,0} value.

7. The UE of claim 1, wherein, when uplink resource allocation type 2 is indicated for the scheduled FDM based on simultaneous multi-panel PUSCH transmission, one of schemes 2-1-1, 2-1-2, 2-2-1 and 2-2-2 are adopted, where, the indicated uplink frequency resources are indicated common resource blocks (CRBs), and wherein:
scheme 2-1-1: among Q allocated interlaces where the Q allocated interlaces are indexed in an order of increasing interlace number as indexed allocated interlace #0 to indexed allocated interlace #Q−1, the indicated CRBs corresponding to a first ┌┐ indexed allocated interlaces are determined as the uplink frequency resources for the PUSCH transmission for the first panel, and the indicated CRBs corresponding to a remaining └┘ indexed allocated interlaces are determined as the uplink frequency resources for the PUSCH transmission for the second panel;
scheme 2-1-2: among Q allocated interlaces where the Q allocated interlaces are indexed in an order of increasing interlace number as indexed allocated interlace #0 to indexed allocated interlace #Q−1, the indicated CRBs corresponding to all even indexed allocated interlaces are determined as the uplink frequency resources for the PUSCH transmission for the first panel, and the indicated CRBs corresponding to all odd indexed allocated interlaces are determined as the uplink frequency resources for the PUSCH transmission for the second panel;
scheme 2-2-1: among S CRBs indicated for the scheduled PUSCH transmission corresponding to indicated interlaces for channel occupancy where the S CRBs are indexed in the order of increasing CRB number as indexed CRB₀ to indexed CRB_{S-1}, the first ┌┐ indexed CRBs are determined as the uplink frequency resources for the PUSCH transmission for the first panel, and the remaining └┘ indexed CRBs are determined as the uplink frequency resources for the PUSCH transmission for the second panel; and
scheme 2-2-2: among S CRBs indicated for the scheduled PUSCH transmission corresponding to indicated interlaces for channel occupancy where the S CRBs are indexed in an order of increasing CRB number as indexed CRB₀ to indexed CRB_{S-1}, all even indexed CRBs are determined as the uplink frequency resources for the PUSCH transmission for the first panel, and all odd indexed CRBs are determined as the uplink frequency resources for the PUSCH transmission for the second panel.

8. The UE of claim 1, wherein the uplink frequency resources for the PUSCH transmission for the first panel and the uplink frequency resources for the PUSCH transmission for the second panel are determined for each subband according to one of schemes 3-1 and 3-2, wherein:
scheme 3-1: among a subband consisting of T physical resource blocks (PRBs) where the T PRBs are indexed in an order of increasing resource block (RB) number as indexed PRB₀ to indexed PRB_{T-1}, first ┌┐ indexed PRBs are determined as the uplink frequency resources for the PUSCH transmission for the first panel, and remaining └┘ indexed PRBs are determined as the uplink frequency resources for the PUSCH transmission for the second panel; and
scheme 3-2: among physical resource groups (PRGs) within the allocated frequency domain resources for a subband that are indexed continuously in increasing order with a first PRG index equal to 0, all even indexed PRGs are determined as the uplink frequency resources for the PUSCH transmission for the first panel, and all odd indexed PRGs are determined as the uplink frequency resources for the PUSCH transmission for the second panel.

9. The UE of claim 8, wherein the at least one processor is further configured to cause the UE to receive a radio resource control (RRC) parameter along with an RRC parameter configured for an FDM-A or an FDM-B scheme, wherein the RRC parameter indicates whether the scheme 3-1 or the scheme 3-2 is used by the UE.

10. The UE of claim 8, wherein the at least one processor is further configured to cause the UE to report a capability that the scheme 3-2 is supported by the UE.

11. The UE of claim 8, wherein when no indication whether scheme 3-1 or scheme 3-2 is received, scheme 3-1 is used by the UE.

12. The UE of claim 8, wherein a field in the scheduling DCI indicates whether scheme 3-1 or scheme 3-2 is used by the UE.

13. The UE of claim 8, wherein the at least one processor is further configured to cause the UE to receive a medium access control control element (MAC CE) to indicate whether scheme 3-1 or scheme 3-2 is used by the UE.

14. A method performed by a user equipment (UE), the method comprising:
receiving downlink control information (DCI) scheduling a frequency division multiplexing FDM) based simultaneous multi-panel physical uplink shared channel (PUSCH) transmission, wherein the DCI indicates uplink frequency resources used for the FDM based simultaneous multi-panel PUSCH transmission; and
determining uplink frequency resources for the PUSCH transmission for a first panel and uplink frequency resources for the PUSCH transmission for a second panel from the indicated uplink frequency resources.

15. A base unit for wireless communication, comprising:
at least one memory; and
at least one processor coupled with the at least one memory and configured to cause the base unit to:
transmit downlink control information (DCI) scheduling a frequency division multiplexing (FDM) based simultaneous multi-panel physical uplink shared channel (PUSCH) transmission, wherein the DCI indicates uplink frequency resources used for the FDM based simultaneous multi-panel PUSCH transmission; and
determine uplink frequency resources for the PUSCH transmission for a first panel and uplink frequency resources for the PUSCH transmission for a second panel from the indicated uplink frequency resources.

16. A processor for wireless communication, comprising:
at least one controller coupled with at least one memory and configured to cause the processor to:
receive downlink control information (DCI) scheduling a frequency division multiplexing (FDM) based simultaneous multi-panel physical uplink shared channel (PUSCH) transmission, wherein the DCI indicates uplink frequency resources used for the FDM based simultaneous multi-panel PUSCH transmission; and
determine uplink frequency resources for the PUSCH transmission for a first panel and uplink frequency resources for the PUSCH transmission for a second panel from the indicated uplink frequency resources.

17. The processor of claim 16, wherein, when uplink resource allocation type 0 is indicated for the scheduled FDM based simultaneous multi-panel PUSCH transmission, among N resource block groups (RBGs) indicated as the uplink frequency resources, where the N RBGs are indexed in an order of increasing frequency as RBG₀ to RBG_{N-1}, all even indexed RBGs are determined as the uplink frequency resources for the PUSCH transmission for the first panel, and all odd indexed RBGs are determined as the uplink frequency resources for the PUSCH transmission for the second panel.

18. The processor of claim 16, wherein, when uplink resource allocation type 1 is indicated for the scheduled FDM based simultaneous multi-panel PUSCH transmission, among contiguous n_{PRB} physical resource blocks (PRBs) indicated as the uplink frequency resources, first
$$⌈ \frac{{n}_{PRB}}{2} ⌉ PRBs$$
are determined as uplink frequency resources for the PUSCH transmission for the first panel, and remaining
$$⌊ \frac{{n}_{PRB}}{2} ⌋ PRBs$$
are determined as uplink frequency resources for the PUSCH transmission for the second panel.

19. The processor of claim 18, wherein, when intra-slot frequency hopping is concurrently configured with an FDM-A or an FDM-B scheme,
a starting resource block (RB) for a first hop of the PUSCH transmission for the first panel is RBₛₜₐᵣₜ,
a starting RB for a second hop of the PUSCH transmission for the first panel is RBₛₜₐᵣₜ+RB_{offset,0},
a starting RB for the first hop of the PUSCH transmission for the second panel is
$${RB}_{start} + ⌈ \frac{{n}_{PRB}}{2} ⌉ ,$$
and
a starting RB for the second hop of the PUSCH transmission for the second panel is
$${RB}_{start} + ⌈ \frac{{n}_{PRB}}{2} ⌉ + {RB}_{offset , 1} .$$

20. The processor of claim 16, wherein the uplink frequency resources for the PUSCH transmission for the first panel and the uplink frequency resources for the PUSCH transmission for the second panel are determined for each subband according to one of schemes 3-1 and 3-2, wherein:
scheme 3-1: among a subband consisting of T physical resource blocks (PRBs) where the T PRBs are indexed in an order of increasing resource block (RB) number as indexed PRB₀ to indexed PRB_{T-1}, first ┌┐ indexed PRBs are determined as the uplink frequency resources for the PUSCH transmission for the first panel, and remaining └┘ indexed PRBs are determined as the uplink frequency resources for the PUSCH transmission for the second panel; and
scheme 3-2: among physical resource groups (PRGs) within the allocated frequency domain resources for a subband that are indexed continuously in increasing order with a first PRG index equal to 0, all even indexed PRGs are determined as the uplink frequency resources for the PUSCH transmission for the first panel, and all odd indexed PRGs are determined as the uplink frequency resources for the PUSCH transmission for the second panel.
